(19) United States
(12) Patent Application Publication
(10) Pub. No.: US 2007/0172693 A1
(43) Pub. Date: Jul. 26, 2007

(54) Fe base alloy having layer and method for production thereof

(75) Inventors: Toshimasa Kumaki, Tochigi-ken (JP); Saomi Sato, Tochigi-ken (JP); Mitsuo Kuwabara, Saitama-ken (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Honda Motor Co., Ltd.

(21) Appl. No.: 10/587,656

(22) PCT Filed: Feb. 3, 2005
(86) PCT No.: PCT/JP05/01581

§ 371 Date: Jul. 28, 2006

(51) Int. Cl. B32B 15/00; B32B 19/00; B32B 9/00

(52) U.S. Cl. 428/689; 428/698; 428/615

(57) ABSTRACT

On respective surfaces of the work pressing site and the body part of the portion having a less diameter of a preliminary formed article comprising SKH51 (a Fe base alloy), a powder of a material containing an element enhancing the hardness of SKH51 and a powder of a material containing an element being contained in SKH51 and not enhancing the hardness of SKH51 are applied respectively. By the heat treatment of the preliminary formed article after the above application, W and the like having been contained in an application agent is diffused into the surface side in the work pressing site, whereas, in the body part of the portion having a less diameter, W and the like having been contained in SKH51 is diffused into the surface side. As a result, a diffusion layer, wherein hardness increases as the distance from the surface decreases, is formed inside the work pressing site, and simultaneously, a concentration change portion, wherein toughness improves as the distance from the surface decreases, is formed in the body part of the portion having a less diameter.

### TECHNICAL FIELD

The present invention relates to a layered Fe-based alloy having at least one part provided with a diffusion layer, in which hardness is increased in a direction oriented from the inside to a surface layer portion, and another part provided with a concentration-varied portion, in which toughness is improved in a direction oriented from the inside to the surface layer portion, and a method for producing the same.

### BACKGROUND ART

A coating may be provided on the surface of a steel material made up of an Fe-based alloy by means of, for example, physical vapor deposition (PVD), chemical vapor deposition (CVD), plating, or anodic oxidation, in order to improve various characteristics including, for example, abrasion resistance, corrosion resistance, and strength of the material. However, in the methods described above, a long period of time is required to form the coating, and the cost for forming the coating is expensive.

In view of the above, as described, for example, in Patent Document 1 and Patent Document 2, procedures have been widely carried out, in which a variety of surface treatments such as carburization, sulfurizing, nitriding, and carbonitriding have been applied to improve various surface characteristics of steel materials without the use of coatings. Further, Patent Document 3 suggests that a compressive stress of 10 kgf/cm² (about 0.1 MPa) may be applied to the surface through a mechanical treatment, such as shot peening or shot blasting, in order to improve abrasion resistance and breakage resistance of a machining blade.

However, improvements in various characteristics brought about by the conventional techniques described in Patent Document 1, Patent Document 2, and Patent Document 3, are limited to the surface of the metal material. For example, in the case of nitriding and carburization, an element is diffused over a distance of only several μm to a maximum of about 200 μm from the surface of the metal material. It is difficult to improve such characteristics at inner positions deeper than the above. Therefore, it cannot be assured that abrasion resistance and breakage resistance are remarkably improved.

Further, in the case of such conventional treatment methods, an interface tends to exist between the formed nitride layer, or the like, and the base metal material. Therefore, it is feared that brittle fractures may be caused at the interface, when placed under a condition in which stresses are concentrated at the interface.

A member has been desired, which simultaneously has both a part in which hardness is improved as well as a part in which toughness is improved. However, in the case of the aforementioned known surface treatment methods, although it is possible to increase hardness throughout the entire member, it is impossible for hardness to be increased at an arbitrary part of the member only, and for toughness to be improved at another part of the member. Further, the various surface treatment methods represented by the conventional techniques described above are surface treatment methods that are principally used to improve hardness. A convenient treatment method, for improving toughness, has remained unknown.

Patent Document 1: Japanese Laid-Open Patent Publication No. 2003-129216

Patent Document 2: Japanese Laid-Open Patent Publication No. 2003-239039

Patent Document 3: Japanese Laid-Open Patent Publication No. 5-171442

### DISCLOSURE OF THE INVENTION

### Problems to be Solved by the Invention

A general object of the present invention is to provide a layered Fe-based alloy in which brittle fractures and concentrations of stress rarely occur, because both hardness and strength are improved.

A principal object of the present invention is to provide a layered Fe-based alloy in which brittle fractures and concentrations of stress rarely occur, because the toughness of a surface layer portion is improved.

Another object of the present invention is to provide a layered Fe-based alloy in which brittle factures and concentrations of stress rarely occur, because the alloy simultaneously has both a part in which hardness of the surface layer portion is increased, and another part in which toughness of the surface layer portion is improved.

Still another object of the present invention is to provide a method for producing a layered Fe-based alloy as described above.

According to one aspect of the present invention, there is provided a layered Fe-based alloy comprising a base material, which is composed of an Fe-based alloy, and a diffusion layer which is formed by allowing a carbide to diffuse into the base material, the diffusion layer having a hardness higher than that of the base material, wherein:

a thickness of the diffusion layer, which is measured from a base point of a surface of the layered Fe-based alloy, is not less than 0.5 mm.

In the layered Fe-based alloy, the carbide is diffused until arriving deeply inside the Fe-based alloy, which makes up the base material. Therefore, excellent hardness and strength are exhibited throughout the diffused region into the interior of the base material. Further, no interface exists in the layered Fe-based alloy between the base material and the diffused carbide region therein. Therefore, concentrations of stress, and hence brittle fractures, rarely occur.

According to another aspect of the present invention, there is provided a layered Fe-based alloy, in which hardness is increased from a surface layer portion to an inside portion thereof, and comprising a diffusion layer that exists on an outer surface of the surface layer portion, wherein:

the diffusion layer contains a carbide formed by carbonizing a first element which has a property to increase hardness of an Fe-based alloy;

a second element other than the first element is contained in the Fe-based alloy, having an amount which is larger in the surface layer portion as compared with the inside portion thereof; and

an amount of the first element increases from the surface layer portion toward the inside portion.

In the layered Fe-based alloy, the first element, which contributes to increasing the hardness of the Fe-based alloy, has an amount which is small on the surface layer portion, and which gradually increases as its position approaches the inside of the Fe-based alloy. Toughness is generally large at a part where the amount of the element that contributes to increasing hardness is small. Therefore, a layered Fe-based alloy is constructed, in which toughness is large at the surface layer portion, and hardness is large at the inside.

Further, in the layered Fe-based alloy, there is no interface between the surface layer portion and the inside portion of the material. Therefore, concentrations of stress, and hence brittle fractures, rarely occur.

According to still another aspect of the present invention, there is provided a layered Fe-based alloy comprising a base material composed of an Fe-based alloy and a diffusion layer formed by allowing a carbide to diffuse into the base material, said diffusion layer having a hardness higher than that of the base material, wherein:

the hardness of the diffusion layer decreases at deeper inside positions, and a thickness of the diffusion layer, which is measured from a base point of a surface of the base material, is not less than 0.5 mm; and

a concentration-varied portion, having a hardness that increases as an amount of an element having a property to increase the hardness of the base material increases from a surface layer portion to an inside portion of the base material, is provided in a part of the base material in which the diffusion layer is absent.

In the diffusion layer, carbide is diffused until arriving at a deep inside position of the Fe-based alloy, which serves as the base material. Therefore, excellent hardness and strength are exhibited up to the inside position. On the other hand, in the concentration-varied portion, the amount of an element that contributes to increasing the hardness of the Fe-based alloy is small within the surface layer portion, and the amount gradually increases at deeper inside positions. Toughness is generally large at the part where the amount of the element that contributes to increasing hardness is small. Therefore, in the concentration-varied portion, toughness is large at the surface layer portion and hardness is larger toward the inside.

That is, the layered Fe-based alloy simultaneously has both a part (diffusion layer) in which hardness is increased as the position thereof approaches the surface layer portion, and another part (concentration-varied portion) in which hardness is lowered as the position thereof approaches the surface layer portion. As described above, according to the present invention, a part that exhibits high hardness and a part that exhibits high toughness are both formed in an identical member. Therefore, the member can preferably be used as a member having desired characteristics that differ depending on the part or location within the member, for example, wherein high hardness is required for a certain part thereof, and high toughness is required for another part thereof. An example of such a member is a forging die.

Further, in the layered Fe-based alloy, no interface exists between the base material and the diffusion layer or the concentration-varied portion. Therefore, concentrations of stress, and hence brittle fractures, rarely occur.

By providing the concentration-varied portion, carbide, which is formed by carbonizing the element having as property for increasing hardness of the base material, is discharged to the outer surface of the concentration-varied portion. As a result, a coating is formed. The layered Fe-based alloy of the present invention may either be one in which the coating is removed, or one in which the coating exists.

The metal carbide is not limited to any particular carbide material per se, so long as the carbide is a substance that improves hardness of the Fe-based alloy. Preferred examples include carbides of Cr, W, Mo, V, Ni, and Mn.

It is preferable that the carbide has a compositional formula of M₆C or M₂₃C₆ wherein M represents a metal element, for the following reason. Namely, carbide, which has a compositional formula represented as described above, is especially excellent in improving the hardness of the Fe-based alloy.

The carbide may be obtained by carbonizing a solid solution of Fe and at least one of Cr, W. Mo, V, Ni, and Mn. In this case, the relative amount of the aforementioned metal carbide is reduced. Therefore, any increase in brittleness, which would be caused by excessively producing metal carbide, is suppressed.

A preferred carbide for the solid solution has a compositional formula represented by (Fe, M)₆C or (Fe, M)₂₃C₆ wherein M represents a metal element.

According to still another aspect of the present invention, there is provided a method for producing a layered Fe-based alloy comprising a base material composed of an Fe-based alloy and a diffusion layer formed by allowing a carbide to diffuse into the base material, the diffusion layer having a hardness higher than that of the base material, wherein a thickness of the diffusion layer, measured from a base point of a surface of the layered Fe-based alloy, is not less than 0.5 mm, the method comprising the steps of:

applying, to a surface of the Fe-based alloy, a metal powder to increase hardness; and

heat-treating the Fe-based alloy with the metal powder applied thereto, so that at least carbon contained in the Fe-based alloy and the metal are reacted with each other to form a carbide, wherein the carbide is diffused into the Fe-based alloy.

When the steps described above are carried out, a layered Fe-based alloy is produced, in which a diffusion layer having a large thickness is formed, without any interface existing between the diffusion layer and the base material. Because of the presence of the diffusion layer, the obtained layered Fe-based alloy is excellent in hardness and strength.

According to still another aspect of the present invention, there is provided a method for producing a layered Fe-based alloy having an increased hardness from a surface layer portion to an inside portion thereof, and further comprising a diffusion layer existing on an outer surface of the surface layer portion, wherein the diffusion layer contains a carbide formed by carbonizing a first element that has a property for increasing hardness of an Fe-based alloy, wherein a second element, other than the first element, is contained in the Fe-based alloy, the second element having an amount which is larger in the surface layer portion as compared with the inside of the Fe-based alloy, and wherein an amount of the first element increases from the surface layer portion to the inside of the Fe-based alloy, the method comprising the steps of:

applying, to a surface of the Fe-based alloy, a powder made up of a substance which contains the second element; and

heat-treating the Fe-based alloy with the powder applied thereto, so that the first element is diffused into the surface layer portion, and the first element reacts with carbon existing in the surface layer portion of the Fe-based alloy to form the carbide.

When heat treatment is applied to the Fe-based alloy, having a surface to which the second element is applied, the first element begins to diffuse while being directed toward the second element. More specifically, the first element, which increases the hardness of the Fe-based alloy, begins to diffuse toward the surface, probably for the following reason. Namely, it is presumed that the second element has a function that causes it to capture the first element.

Therefore, when the steps described above are carried out, the first element is diffused and unevenly distributed into the uppermost region of the surface layer portion. Accordingly, as diffusion layer, in which an amount of the first element is largest, is provided on the outer surface of the surface layer portion.

As a result of the uneven distribution of the first element in the outer surface of the surface layer portion as described above, an amount of the first element is smallest at a position just underneath the diffusion layer in the surface layer portion, and the amount gradually increases at deeper inside positions. That is, the hardness of the obtained layered Fe-based alloy is lowest just underneath the diffusion layer. As described above, the part of the Fe-based alloy that exhibits low hardness generally tends to be large in toughness. Therefore, the toughness of the layered Fe-based alloy is large on the side of the surface layer portion, as compared with the inside portion thereof. In other words, a layered Fe-based alloy is obtained, in which toughness is high on the side of the surface layer portion, and hardness is high at the inside portion thereof.

That is, according to the present invention, a layered Fe-based alloy, in which toughness of the surface layer portion is improved, is easily obtained by performing a convenient operation in which heat treatment is carried out after applying a powder to a surface of the Fe-based alloy.

According to still another aspect of the present invention, there is provided a method for producing a layered Fe-based alloy, comprising the steps of:

applying, to a surface of an Fe-based alloy, a powder made up of a substance containing a first element which increases hardness, while applying, to a part of the Fe-base alloy other than where the first element was applied, a powder made up of a substance containing a second element, wherein the second element is different from the first element and is contained in the Fe-based alloy, or applying, to the surface of the Fe-based alloy, the powder made up of the substance containing the second element, while applying the substance containing the first element to a part of the Fe-based alloy other than where the second element was applied;

applying heat treatment to the Fe-based alloy after applying the powders thereto, each powder containing the first element or the second element respectively, so that a diffusion layer, having a thickness not less than 0.5 mm and a hardness higher than that of a base material, is provided at the part to which the powder of the substance containing the first element was applied, while a concentration-varied portion, in which a hardness thereof is increased as an amount of an element having a property to increase the hardness of the base material is increased from a surface layer portion to an inside portion of the base material, is provided at the part to which the powder of the substance containing the second element was applied,

wherein the diffusion layer is provided such that the first element is diffused into the Fe-based alloy, thereby diffusing carbide into the Fe-based alloy by causing a reaction with carbon of the Fe-based alloy, and

wherein the concentration-varied portion is provided such that the first element of the Fe-based alloy is diffused from the inside portion to the surface layer portion of the Fe-based alloy, and carbon, which exists in the surface layer portion, reacts with the first element to form a carbide-containing coating, thereby discharging the first element from the base material.

When the steps described above are carried out, a layered Fe-based alloy may be produced, in which a diffusion layer having a large thickness is formed, without any interface existing between the diffusion layer and the base material. The part of the layered Fe-based alloy in which the diffusion layer exists is excellent in terms of both hardness and strength.

On the other hand, at the part where the powder made up of the substance containing the second element has been applied, the first element begins to diffuse while being directed toward the second element. More specifically, the first element, which increases hardness of the Fe-based alloy, begins to diffuse toward the surface, probably for the following reason. Namely, it is presumed that the second element has a function that causes it to capture the first element. Accordingly, the first element is diffused to the uppermost region of the surface layer portion. Further, a coating, which contains the first element, is formed on the outer surface of the surface layer portion.

As a result of uneven distribution of the first element to the outer surface of the surface layer portion, as described above, the amount of the first element is smallest just under the coating, while gradually increasing in a direction from the surface layer portion toward the inside. That is, the hardness of the obtained layered Fe-based alloy is the lowest just underneath the coating. As described above, the part of the Fe-based alloy that has a small hardness generally also is large in toughness. Therefore, the part provided with the coating is larger in toughness on the side of the surface layer portion, as compared with the inside thereof. In other words, a layered Fe-based alloy is obtained, in which toughness is high on the side of the surface layer portion, and hardness is high at the inside thereof.

That is, according to the present invention, the layered Fe-based alloy simultaneously has a part with increased hardness at the surface layer portion, and another part with improved toughness at the surface layer portion, wherein the layered Fe-based alloy is easily obtained by performing a convenient operation, in which heat treatment is carried out after applying the powder.

The powder may be blended with a powder of a substance containing the first element. In this case, it is appropriate to set the blending ratio between the powder of the substance containing the first element and the powder of the substance containing the second element, depending on heat treatment conditions and the type of Fe-based alloy used.

It is preferable for Cr, W, Mo, V, Ni, or Mn to be used as the first element, because in doing so, hardness of the Fe-based alloy is improved.

On the other hand, there is no special limitation imposed on the second element, provided that it is a substance containing an element that exists within the Fe-based alloy, and providing that it does not contribute to increasing the hardness of the Fe-based alloy. However, it is preferable to use C, Si, Cu, Ti, Al, and Mg. In particular, C and Si provide excellent effectiveness with respect to diffusing the first element. On the other hand, Cu, Ti, Al, and Mg provide excellent effectiveness with respect to shutting off oxygen. Further, the intermetallic compound produced thereby is fine and minute, and possesses improved qualities of heat resistance. Hence, an Fe-based alloy, which is excellent in the high temperature strength, may be obtained.

A given margin of the coating may be removed, for example, by performing cutting machining. In this case, the part having high hardness is decreased, while the part having high toughness remains. Therefore, a layered Fe-based alloy, on which bending machining or the like may be easily performed, can be obtained.

Further, the heat treatment may be performed in a nitrogen atmosphere, wherein the carbide is nitrided to form a carbonitride. In this case, toughness is improved without lowering the hardness of the surface layer portion of the layered Fe-based alloy.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 schematically shows a perspective view illustrating an entire forging punch as a layered Fe-based alloy;

FIG. 2 shows a magnified longitudinal sectional view illustrating major portions of a workpiece-pressing part of the forging punch shown in FIG. 1;

FIG. 3 shows a magnified longitudinal sectional view illustrating major portions of a trunk of a small diameter section of the forging punch shown in FIG. 1;

FIGS. 4A to 4F illustrate a process flow for producing the forging punch shown in FIG. 1;

FIG. 5 shows a graph illustrating HRC measured in a direction oriented from a surface to an inside portion of a cut surface of the workpiece-pressing part of the forging punch;

FIG. 6 shows a graph illustrating HRC measured in a direction oriented from a surface to an inside portion of a cut surface of the trunk of the small diameter section of the forging punch;

FIG. 7 shows a table illustrating compositions and ratios of applying agents;

FIG. 8 shows a graph illustrating the relationship between HRC and distance from the surface, for test pieces made of DH31;

FIG. 9 shows a table illustrating compositions and ratios of applying agents;

FIG. 10 shows a graph illustrating the relationship between HRC and distance from the surface, for test pieces made of SKH51; and

FIG. 11 shows a graph illustrating the relationship between HRC and distance from the surface, for test pieces made of SKD11.

### BEST MODE FOR CARRYING OUT THE INVENTION

The layered Fe-based alloy of the present invention will be explained in detail below with reference to the accompanying drawings, which exemplify preferred embodiments of the invention in relation to the method for producing the same.

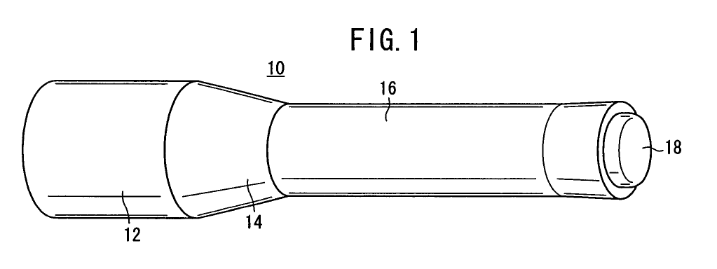

FIG. 1 schematically shows a perspective view, illustrating an entire forging punch formed of a layered Fe-based alloy according to a first embodiment. The forging punch 10 is manufactured using SKH51 as a raw material (base material). The forging punch 10 has a large diameter section 12, a diametrally reduced section 14 connected to the large diameter section 12 and having diameters thereof gradually reduced in a tapered shape, a small diameter section 16, and a curved protruding section 18 that protrudes from one end of the small diameter section 16. The curved protruding section 18 and the forward end of the small diameter section 16 are used to press a workpiece, which is accommodated in a cavity of an unillustrated die, so that the workpiece is formed to have a predetermined shape. That is, the forward end of the small diameter section 16 and the curved protruding section 18 serve together as a workpiece-pressing part.

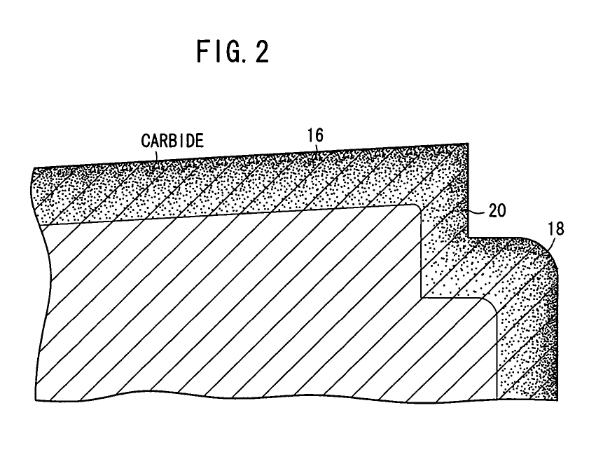

A cross section of the workpiece-pressing part is magnified and shown in FIG. 2. As shown in FIG. 2, a diffusion layer 20, which is formed by allowing a metal carbide to diffuse into an SKH51 base material, is provided at a surface layer portion of the workpiece-pressing part.

The metal element that is used for forming the carbide is not specifically limited, provided that hardness of the SKH51 base material is improved. However, preferred examples include Cr, W, Mo, V, Ni, and Mn. The diffusion layer 20, which is formed by diffusion of a carbide of the metal elements described above, exhibits high hardness and high strength. Therefore, the workpiece-pressing part of the forging punch 10, in which the diffusion layer 20 exists, exhibits high hardness and high strength as compared with, for example, the large diameter section 12 and the diametrally reduced section 14 in which the diffusion layer 20 does not exist. In other words, the workpiece-pressing part, provided with the diffusion layer 20, exhibits high hardness and high strength as compared with the other parts of the forging punch 10.

The carbide may be a carbide having a compositional formula represented by M₇C₃, in which the metal element is represented by M. However, it is preferable to use a carbide represented by M₆C (such as Cr₆C, W₆C, and Mo₆C) or a carbide represented by M₂₃C₆, for the following reason. Namely, in this case, the carbide is highly excellent in its effect to improve hardness and strength.

If too much M₆C and/or M₂₃C₆ is used and exists excessively, the forging punch 10 exhibits brittleness. Accordingly, it is preferable to form a carbide from a solid solution of Fe and the above-described metal elements. That is, the carbide may be represented by, for example, (Fe, M)₆C and (Fe, M)₂₃C₇. When such a carbide is produced, the relative amount of M₆C and/or M₂₃C₆ is reduced. Therefore, the forging punch 10 is reliably prevented from becoming brittle.

In this arrangement, the thickness of the diffusion layer 20, or in other words the distance at which the carbide is diffused, is at least at a depth of 0.5 mm (500 μm) from the surface of the forging punch 10. The thickness or distance usually is from 3 to 7 mm (3,000 to 7,000 μm), and the thickness or distance occasionally reaches 15 mm (15,000 μm), at a maximum. Such values are extremely large, as compared with diffusion distances obtained using ordinary nitriding or carburization, which only are of several tens of μm, or reaching about as much as 200 μm. That is, in the embodiment of the present invention, the carbide is diffused extremely deeply as compared with depths obtained when the element is introduced using a conventional surface treatment technique.

In the workpiece-pressing part provided with the diffusion layer 20 as described above, hardness of the base material is improved throughout the depth at which the carbide is diffused. That is, hardness and strength are increased throughout a region that penetrates deep inside of the forging punch 10. As a result, abrasion resistance is improved internally, and the forging punch 10 is prevented from becoming deformed.

The diffusion layer 20 is formed such that the metal element, which is diffused from the surface of the base material, produces a carbide, as shall be described later on. Therefore, concentration of the carbide is the highest at the surface, and the concentration of the carbide gradually decreases in a direction oriented toward the inside of the base material.

Further, because the concentration of the carbide gradually decreases as described above, no distinct interface exists between the diffusion layer 20 and the base material. Accordingly, concentration of stress is avoided, and therefore, an increase in brittleness which would otherwise be caused by diffusion of the metal element, is avoided. However, for illustrative purposes in FIG. 2, a boundary line is conveniently shown between the diffusion layer 20 and the base material, simply in order to clarify the presence of the diffusion layer 20.

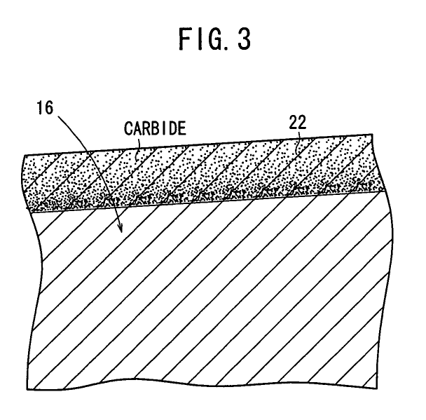

On the other hand, in FIG. 3, a magnified sectional view is shown, illustrating major portions of a trunk of the small diameter section 16 that extends from the workpiece-pressing part. As illustrated, a concentration-varied portion 22, in which concentration of the metal element inside of the base material SKH51 changes, exists at the surface layer portion of the workpiece-pressing part.

The metal element, the concentration of which changes within the concentration-varied portion 22, is an element used for fabricating SKH51, wherein the element contributes to increasing the hardness of SKH51. Specifically, the element includes, for example, Cr, W, Mo, V, Ni, and Mn, in the same manner as described above.

The metal element, as described above, usually exists in the form of an alloy or a carbide. The carbide may be a carbide for which the compositional formula thereof is represented by M₆C (such as Cr₆C, W₆C, and Mo₆C) or wherein the compositional formula is represented by M₂₃C₆. However, if too much M₆C or M₂₃C₆ is used and exists excessively, the forging punch 10 exhibits brittleness. In order to avoid this inconvenience, it is preferable to provide a carbide in the form of a solid solution of Fe and M, i.e., a carbide represented, for example, by (Fe, M)₆C and (Fe, M)₂₃C₇, so that the relative amount of M₆C or M₂₃C₆ is reduced.

Concentration of the metal element gradually increases in a direction oriented inwardly from the uppermost position of the concentration-varied portion 22. That is, concentration of the metal element is lowest at the uppermost position of the concentration-varied portion 22. Therefore, the hardness of the concentration-varied portion 22 is smallest at the uppermost position, and the hardness is increased in the direction oriented to the inside.

As described above, the concentration-varied portion 22, in which an element for increasing hardness of SKH51 gradually increases in a direction oriented toward the inside, is formed at the surface layer portion of the small diameter section 16. The concentration-varied portion 22 is provided such that an element contained in SKH51 is diffused from the inside thereof toward the surface layer portion, and the element is discharged, as shall be described later on. A coating, which is formed on the surface layer portion during this process, is then cut off and removed by means of mechanical machining.

In general, hardness and toughness exhibit a trade-off relationship with each other. Namely, when hardness is decreased, toughness is increased, and vice versa. As described above, the amount of the element that contributes to increasing hardness is small at the uppermost position of the concentration-varied portion 22. Therefore, toughness is large at the surface layer portion of the trunk of the small diameter section 16, as compared with the inside portion thereof. That is, the surface layer portion of the trunk exhibits higher toughness as compared with an SKH51 material in which a concentration-varied portion 22 has not been formed. Therefore, since the trunk itself has increased toughness, brittle fractures rarely occur therein. Consequently, for example, breakage rarely occurs in the trunk, as compared with a situation in which the concentration-varied portion 22 is not provided in the large diameter section 12 or the like.

Concentration of the metal element (or in other words, concentration of the alloy and/or the carbide thereof) is lowest at the surface layer portion of the trunk, with the concentration thereof gradually increasing at inwardly deeper positions. Therefore, no distinct interface is present between the concentration-varied portion 22 and the base material. Thus, occurrence of stress concentration is avoided, and hence any increase in brittleness, which might otherwise be caused by providing the concentration-varied portion 22, can likewise be avoided. However, in FIG. 3, in order to more clearly show the presence of the concentration-varied portion 22, a boundary line is illustrated for convenience between the concentration-varied portion 22 and the base material.

An element, which is contained in SKH51, and which does not contribute to increasing hardness of SKH51, and which is specifically exemplified, for example, by C, Si, Cu, Ti, Al, and Mg, is also present, for example, in a form of an alloy or a carbide, within the concentration-varied portion 22. As described later on, when such an element is provided on the surface side during heat treatment, the metal element such as Cr, W, Mo, V, Ni, and Mn is diffused in a direction oriented toward the outer surface of the small diameter section 16.

The forging punch 10, constructed as described above, may be used, for example, when warm forging is applied to a workpiece. During this process, a workpiece-pressing part of the forging punch 10 presses the workpiece. As described above, the workpiece-pressing part exhibits both high hardness and high strength owing to the presence of the diffusion layer 20, and toughness of the workpiece-pressing part is ensured. Therefore, the workpiece-pressing part is scarcely abraded and breakage thereof rarely occurs, even when forging is repeatedly performed, and thus the workpiece-pressing part has a long service life. The carbide may be a carbonitride.

Simultaneously, a load is applied to the trunk of the small diameter section 16. As described above, the trunk exhibits high toughness owing to the high toughness of the surface layer portion thereof. Therefore, breakage of the trunk rarely occurs, even when forging is repeatedly performed. That is, when an element that contributes to increasing hardness of SKH51 is diffused and discharged to the surface layer portion, thereby forming the concentration-varied portion 22, the service life of the forging punch 10 can be prolonged.

The forging punch 10 may be produced, for example, as follows.

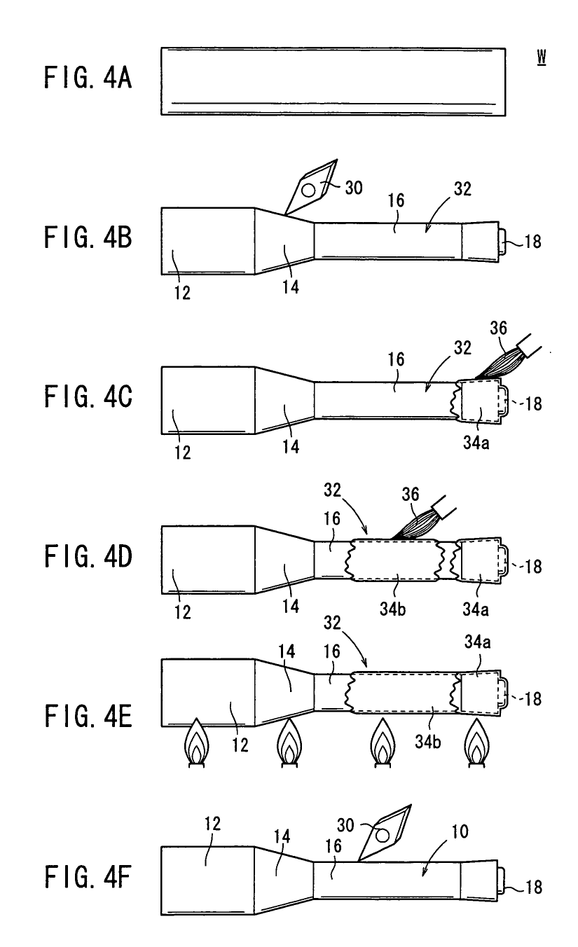

At first, as shown in FIG. 4B, cutting machining is applied to a workpiece W using a cutting tool 30, wherein, as shown in FIG. 4A, the workpiece W has a cylindrical shape and is composed of SKH51, in order to obtain a preformed member 32 having a shape corresponding to the shape of the forging punch 10.

Subsequently, as shown in FIG. 4C, a powder of a metal to be diffused is applied to the surface of a part of the preformed member 32 that is to be converted into the workpiece-pressing part. For example, when W is diffused, a powder blended with a W powder may be applied, or when Cr is diffused, a powder blended with a Cr powder may be applied. The amount at which the powder is applied should be an amount that, for example, successfully produces W₆C, Cr₆C, or the like.

On the other hand, a powder of a substance containing another element, which is an element present in SKH51 and which does not increase the hardness of SKH51 (i.e., an element other than Cr, W, Mo, V, Ni, Mn or the like), is applied to the surface of a part of the preformed member 32 that is to be converted into the trunk of the small diameter section 16. Preferred examples of such a powder include powders composed of C, Si, Cu, Ti, Al, and Mg.

In any case, the powders may be applied in the form of applying agents 34a, 34b, each of which is prepared by dispersing the powder in a solvent. As for the solvent, it is preferable that an organic solvent be selected, which is evaporated or vaporized with ease, including, for example, acetone and alcohol. When the applying agent 34a, which is applied to the workpiece-pressing part, is prepared, a powder of W, Cr or the like may be dispersed in the solvent. When the applying agent 34b, which is applied to the trunk, is prepared, a powder of C, Si or the like may be dispersed in the solvent.

Usually, an oxide film is spontaneously formed and exists on the surface of the SKH51 base material. In order to diffuse the above elements in this state, it is necessary to use an extremely large amount of thermal energy, so that the elements can pass through the oxide film. In order to avoid this inconvenience, it is preferable to mix a reducing agent, which is capable of reducing the oxide film, into the respective applying agents 34a, 34b.

Specifically, a substance, which acts as a reducing agent on the oxide film and which does not react with SKH51, is dispersed or dissolved in the solvent. Preferred examples for such a reducing agent include, without being limited thereto, respective resins of nitrocellulose, polyvinyl, acrylic, melamine, styrene, and epoxy. The concentration of the reducing agent should be about 5% or more.

The applying agents 34a, 34b, in which the above-described substances are dissolved or dispersed, are applied respectively to surfaces of the workpiece-pressing part and the trunk of the small diameter section 16, by means of a brush-applying method, using a brush 36 as shown in FIGS. 4C and 4D respectively. Of course, other known application techniques apart from a brush-applying method may also be used. It goes without saying that the sequence of application of the applying agents 34a, 34b may be reversed.

Subsequently, a heat treatment is applied to the preformed member 32, in which the applying agent 34a is applied to the surface of the workpiece-pressing part, and the applying agent 34b is applied to the surface of the trunk of the small diameter section 16. Heat treatment is carried out, for example, by applying burner flames 38 on one end surface side of the preformed member 32, as shown in FIG. 4E. Of course, the heat treatment may also be carried out in an inert atmosphere in a heat treating furnace.

As the temperature is raised during this process, the reducing agent begins to decompose at about 250° C., and carbon and hydrogen are produced. The oxide film on the preformed member 32 disappears as a result of reduction, under the action of carbon and hydrogen. Therefore, it is unnecessary for W, Cr or the like to pass through an oxide film on the workpiece-pressing part, and likewise, it is unnecessary for C, Si or the like to pass through an oxide film on the trunk of the small diameter section 16. Therefore, the time required for diffusion is shortened, and the required thermal energy may be reduced.

As the temperature-raising process continues, C, which is a constitutive element of the SKH51 base material and C, which is produced by decomposition of the reducing agent, are reacted with W, Cr or the like in the workpiece-pressing part, to produce, for example, W₆C, Cr₆C, W₂₃C₆, and Cr₂₃C₆. When Fe further participates in such a reaction, for example, (Fe, W)₆C, (Fe, Cr)₆C, (Fe, W)₂₃C₆, and (Fe, Cr)₂₃C₆ are also produced.

The produced carbides, such as W₆C, Cr₆C, (Fe, W)₆C, and (Fe, Cr)₆C, are instantaneously decomposed, and return to states of being Fe, W, and Cr. Among them, W and Cr are subsequently bonded to C and Fe, which are constitutive elements of the base material existing at deeper inner positions of the base material, and C, which exists in a liberated or free state at deeper inner positions of the base material, to newly produce again, for example, W₆C, Cr₆C, (Fe, W)₆C, and (Fe, Cr)₆C. These materials, W₆C, Cr₆C, (Fe, W)₆C, and (Fe, Cr)₆C, are also instantaneously decomposed and return to states of being W and Cr. After that, they are bonded to C and Fe, which are constitutive elements of the base material existing at further deeper inner positions of the base material, and C, which exists in a liberated or free state at the further deeper inner positions of the base material, to produce, for example, W₆C, Cr₆C, (Fe, W)₆C, and (Fe, Cr)₆C once again. The carbides are repeatedly decomposed and produced, as described above, and thus the carbides are diffused into deep inner portions of the base material.

In this way, W₆C, Cr₆C, (Fe, W)₆C, and (Fe, Cr)₆C are diffused into the inside portion of the base material. As a result, the diffusion layer 20 is formed (see FIG. 2). The carbide concentration is gradually decreased throughout the diffusion layer 20, and no distinct interface is formed between the base material and the terminal end portion of the carbide diffusion inside the base material. Therefore, the occurrence of brittle fractures is avoided, and hence toughness of the workpiece-pressing part, in which the diffusion layer 20 is formed, is ensured. The thickness of the diffusion layer 20, i.e., the distance of carbide diffusion, ranges to a depth of about 15 mm from the surface, at a maximum.

The diffusion layer 20 may be formed by diffusing a carbide of Mo, V, or Ni into an inside portion of the base material, in the same manner as described above.

On the other hand, for example, W and Cr, which are constitutive elements of SKH51, are reacted, for example, with C produced by decomposition of the reducing agent, and with free C contained in SKH51, at the trunk of the small diameter section 16. As a result, for example, W₆C, Cr₆C, W₂₃C₆, and Cr₂₃C₆ are produced. When Fe is mixed in the applying powder, for example, (Fe, W)₆C, (Fe, Cr)₆C, (Fe, W)₂₃C₆, and (Fe, Cr)₂₃C₆ are further produced. In this process, the velocity at which Fe becomes diffused is larger than in the case of C, Si, Cu, Ti, Al, and Mg. Therefore, concentration of Fe contained in the applying agent 34b is large on the inner side of the concentration-varied portion 22.

The produced carbides, such as W₆C, Cr₆C, (Fe, W)₆C, and (Fe, Cr)₆C, are instantaneously decomposed, and return to states of being Fe, W, and Cr. Among these materials, W and Cr are diffused and moved toward the surface, probably for the following reason. Namely, it is presumed that C, Si and the like, which exist on the surface side, are highly capable of forming carbide or silicide, and therefore have a function that causes them to capture W, Cr and the like. Moreover, when Cu, Ti, Al, or Mg is contained in the applying agent, such an element also acts to shut off oxygen, and therefore, the SKH51 material is also prevented from becoming oxidized.

In the diffusion process described above, W and Cr are bonded to C and Fe, which are constitutive elements of SKH51 existing on the surface side of the preformed member 32, and to C which exists in a free state on the surface side to newly produce again, for example, W₆C, Cr₆C, (Fe, W)₆C, and (Fe, Cr)₆C. Such reproduced W₆C, Cr₆C, (Fe, W)₆C, and (Fe, Cr)₆C are also instantaneously decomposed, and return to a state of being W and Cr. After that, they are bonded to C and Fe, which exist on a further surface side of the preformed member 32, and to C which exists in a free state on the surface side, to produce, for example, W₆C, Cr₆C, (Fe, W)₆C, and (Fe, Cr)₆C once again. As the carbides are repeatedly decomposed and reproduced, as described above, the carbides are diffused toward the outer surface of the preformed member 32. As a result, a coating composed of the carbide is formed on the outer surface, in which the carbide is chemically stable. Therefore, the preformed member 32 is converted into a layered Fe-based alloy, having a coating formed on an outer surface of the surface layer portion. The thickness of the coating is about 0.5 mm.

As described above, W and Cr, which exist on the side of the surface layer portion, are diffused, for example, as W₆C, Cr₆C, (Fe, W)₆C, and (Fe, Cr)₆C into the outer surface of the preformed member 32. As a result, the concentrations of W, Cr and the like are lowest at the surface layer portion disposed just underneath the coating, and such concentrations gradually increase at inwardly deeper positions. That is, a concentration-varied portion 22 is formed (see FIG. 3), in which concentrations of W, Cr and the like are gradually increased. Therefore, as described above, no distinct interface is formed between the base material and the terminal end of the concentration-varied portion 22. Therefore, brittle fractures, which might otherwise occur as a result of providing the concentration-varied portion 22, can be avoided.

On the other hand, C, Si, Cu, Ti, Al, Mg and the like, which are contained in the applying agent, are diffused within the concentration-varied portion 22, and remain as alloys and carbides in the concentration-varied portion 22. Such elements do not contribute to increasing the hardness of SKH51. Therefore, diffusion of such elements does not increase hardness within the concentration-varied portion 22.

Finally, as shown in FIG. 4F, finishing machining is applied to the preformed member 32, using the cutting tool 30 or a grinding wheel, to produce the forging punch 10. During this process, the coating is cut and removed from the trunk of the small diameter section 16. As described above, the thickness of the coating is about 0.5 mm, and therefore, the coating can be cut and removed with relative ease.

As a result of cutting and removing the coating, the concentration-varied portion 22 is exposed. As described above, toughness is highest at the uppermost region of the concentration-varied portion 22. Thus, toughness is maximally increased at the surface of the trunk of the small diameter section 16.

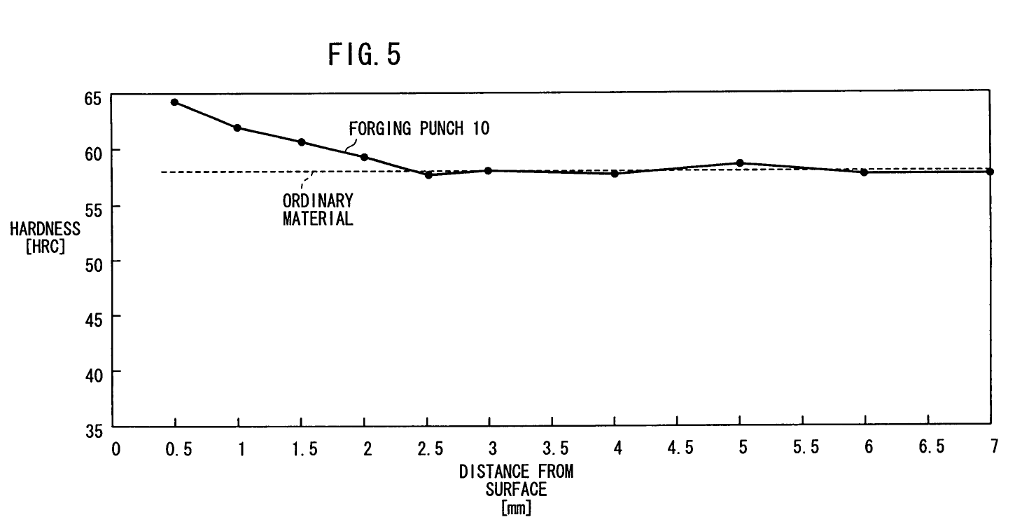

FIG. 5 shows, together with HRC of ordinary SKH51, the C Scale Rockwell hardness (HRC), measured in a direction oriented from the surface side to an inside portion, of a cross sectional surface of a part corresponding to the workpiece-pressing part, after the forging punch 10 obtained as described above has been cut in the longitudinal direction. According to FIG. 5, in this case, it is clear that hardness is increased until arriving at an inside position 2.5 mm from the surface.

Further, the strength of a test piece of JIS Z 22014, formed with a diffusion layer 20 in the same manner as described above, is remarkably improved, when compared with the strength of a test piece having the same dimension but formed without the diffusion layer 20. Specifically, the tensile strength of the test piece formed without a diffusion layer 20 is about 1,800 MPa, while the tensile strength of the test piece having the diffusion layer 20 is about 2,200 MPa. More specifically, the tensile strength of the latter test piece is about 1.2 times the tensile strength of the former.

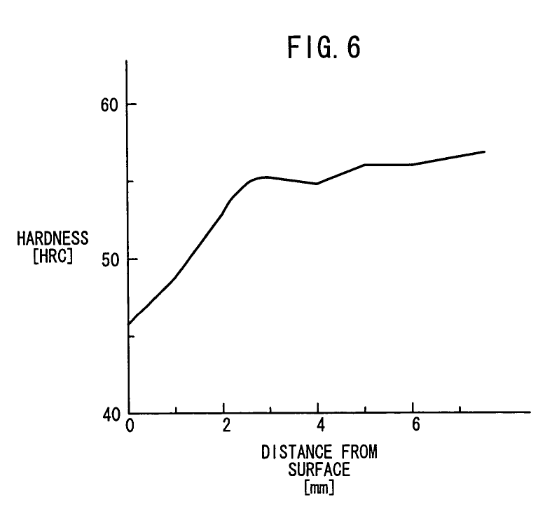

On the other hand, FIG. 6 shows the C Scale Rockwell hardness (HRC), measured in a direction oriented from the surface side to an inside portion, of a cross sectional surface of a part corresponding to the trunk of the small diameter section 16. According to FIG. 6, in this case, it is clear that HRC is increased in a direction oriented from the surface to an inside portion, until arriving at a depth of about 4 mm. In other words, it is clear that the toughness at the surface layer portion is larger than that of the inside portion.

As described above, the punch 10 according to the first embodiment has a part in which strength is improved (i.e., the part in which the diffusion layer 20 exists) and another part in which toughness is improved (i.e., the part in which the concentration-varied portion 22 exists). However, the present invention may also encompass an embodiment having only a strength-improved part, or an embodiment having only a toughness-improved part. Such embodiments shall hereinafter be referred to as second and third embodiments, respectively.

That is, a punch in accordance with the second embodiment is constructed in the same manner as the punch 10 shown in FIG. 1, except that the concentration-varied portion 22 is not present in the trunk of the small diameter section 16. The punch of the second embodiment has a diffusion layer 20 formed at the workpiece-pressing part, composed of the forward end of the small diameter section 16 and the curved protruding section 18. Hardness and strength are increased at the workpiece-pressing part of the punch according to the second embodiment, as compared with, for example, the large diameter section 12 and the diametrally reduced section 14, in the same manner as in the punch 10, owing to the presence of the diffusion layer 20.

It may be appreciated that the punch according to the second embodiment can be produced by applying only the applying agent 34a to the workpiece-pressing part, and thereafter, applying a heat treatment to the applied portion, with reference to FIGS. 4A to 4F.

On the other hand, a punch in accordance with the third embodiment is constructed in the same manner as the punch 10 shown in FIG. 1, except that the diffusion layer 20 is not present in the workpiece-pressing part. The punch according to the third embodiment has a concentration-varied portion 22 formed at the trunk of the small diameter section 16. Toughness is increased at the trunk of the small diameter section 16 of the punch of the third embodiment, as compared with, for example, the workpiece-pressing part, the large diameter section 12, and the diametrally reduced section 14, in the same manner as in the punch 10, owing to the presence of the concentration-varied portion 22. Therefore, breakage is unlikely to occur.

It shall be appreciated that the punch, according to the third embodiment, can be obtained by applying only the applying agent 34b to the trunk of the small diameter section 16, and thereafter applying a heat treatment to the applied portion, with reference to FIGS. 4A to 4F.

First to third embodiments of the present invention have been explained with reference to a forging punch, manufactured using an Fe-based alloy. However, the invention is not limited to forging punches per se. It goes without saying that the principles of the invention may be applied to other devices or members.

In the above embodiments, the coating, which is formed on the outer surface of the trunk of the small diameter section 16, is cut and removed. However, a product may be manufactured and used without removing the coating.

Further, a powder of a substance, which contains an element having a property for increasing hardness of the Fe-based alloy, may be added to the applying agent 34b. In this case, a blending ratio between the powder and C, Si, Cu, Ti, Al, and Mg may be appropriately set, depending on the type of Fe-based alloy used and the conditions of heat treatment.

Further, heat treatment may be performed in a nitrogen atmosphere in a heat treatment furnace. In this case, a carbide of W, Cr or the like, which remains in the concentration-varied portion 22, is nitrided to form a carbonitride. The particles which make up such a metal carbonitride have shapes comprising rounded ends. Brittle fractures scarcely occur between particles having such shapes as described above. Therefore, toughness of the concentration-varied portion 22 can be increased, and a layered Fe-based alloy, even more superior in toughness, can be obtained.

For example, Mo can be also removed from molybdenum steel by applying the applying agent 34b, and performing operations in the same manner as described above.

Further, the heat treatment may be performed after application of the applying agent 34b. Thereafter, the obtained product may be used as a punch, or as other members, without cutting and removing the diffusion layer formed at the applied part.

### EXAMPLE 1

A columnar member, having a diameter of 80 mm at a bottom surface thereof, and a height of 80 mm, was manufactured using a DH31 hot die steel.

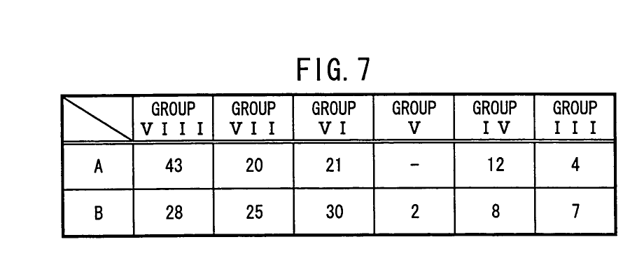

On the other hand, powders (particle size: 10 to 70 μm) of substances belonging to Groups III to VIII of the periodic table were added, in the ratios shown in FIG. 7, to acetone solutions containing epoxy resin by 10%, to prepare two applying agents A and B. A substance, which improves hardnesses of various steel materials, generally represented by DH31, was principally contained in the applying agent A. A substance, which exists in various steel materials and which does not contribute to increasing hardness, was principally contained in the applying agent B.

Thereafter, the respective applying agents A and B were applied to different parts on the surface of an identical columnar member. Such application was performed by means of brush-application, wherein the thickness of each of the applying agents A and B was 1 mm.

The respective applying agents A and B were spontaneously dried, and then the temperature was retained at 1,000 to 1,180° C. for 2 hours, to perform a hardening process. Subsequently, the temperature was retained at 500 to 600° C. for 2 hours, to perform a tempering process.

Subsequently, the columnar member was cut along the height direction thereof. HRC was measured at respective positions at every 0.5 mm along the height direction, from the center of the bottom surface, for the parts to which the applying agent A or the applying agent B had been applied respectively. Such measurements were performed after cutting and removing all of the coating formed at the part to which the applying agent B had been applied.

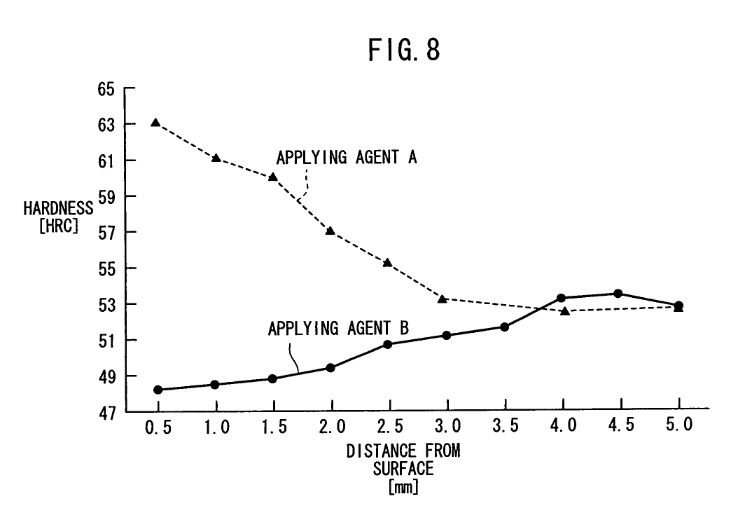

FIG. 8 shows the relationship between HRC and distance from the surface for the respective parts in combination. HRC is approximately 52 to 54 in the case of untreated DH31. On the other hand, it is clear that hardness was increased when the applying agent A was applied, while hardness was decreased when the applying agent B was applied. According to this fact, it may be appreciated that toughness was improved by application of the applying agent B.

Further, according to this fact, it shall be understood that the part in which hardness was improved, and the part in which toughness was improved, could individually be manufactured, by changing the type of applying agent used, even when the same heat treatment was applied to an identical member.

### EXAMPLE 2

Columnar members, each having a diameter of 80 mm at a bottom surface thereof, and a height of 80 mm, were manufactured using an SKH51 high speed tool steel and an SKD11 die steel.

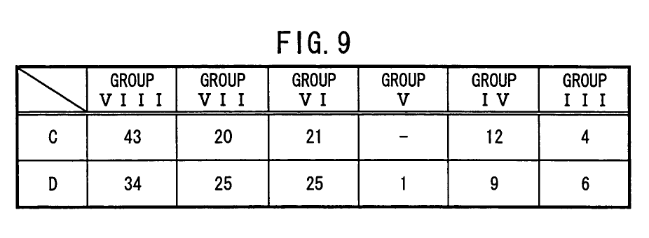

On the other hand, powders (particle size: 10 to 70 μm) of substances, belonging to Groups III to VIII of the periodic table, were added in the ratios shown in FIG. 9 to acetone solutions containing epoxy resin by 10% to, prepare two applying agents A and B.

Thereafter, the applying agent A was applied over the entire surface of the columnar member made of SKH51 described above, while the applying agent B was applied over the entire surface of the columnar member made of SKD11 described above. Such applications were performed by means of brush-application, wherein the thickness of each of the applying agents A and B was 1 mm.

The applying agents were spontaneously dried, and then retained at a temperature of 1,000 to 1,180° C. for 2 hours, to perform a hardening process. Subsequently, the temperature was retained at 500 to 600° C. for 2 hours, to perform a tempering process.

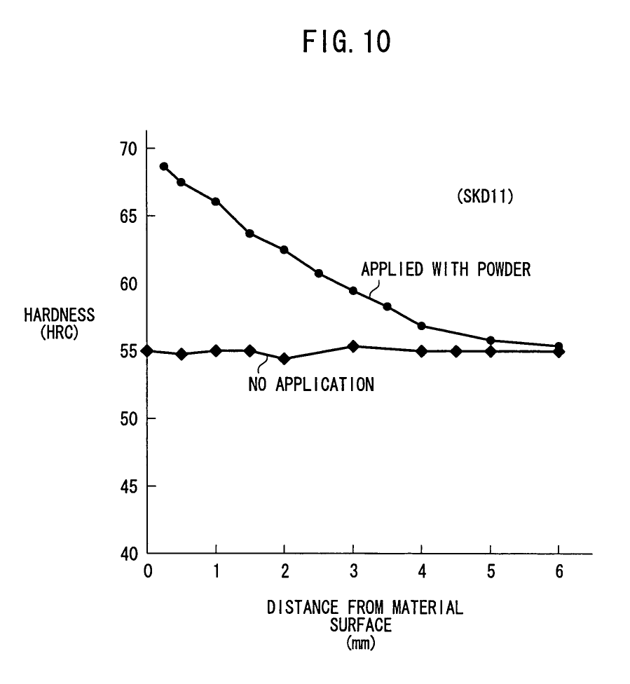

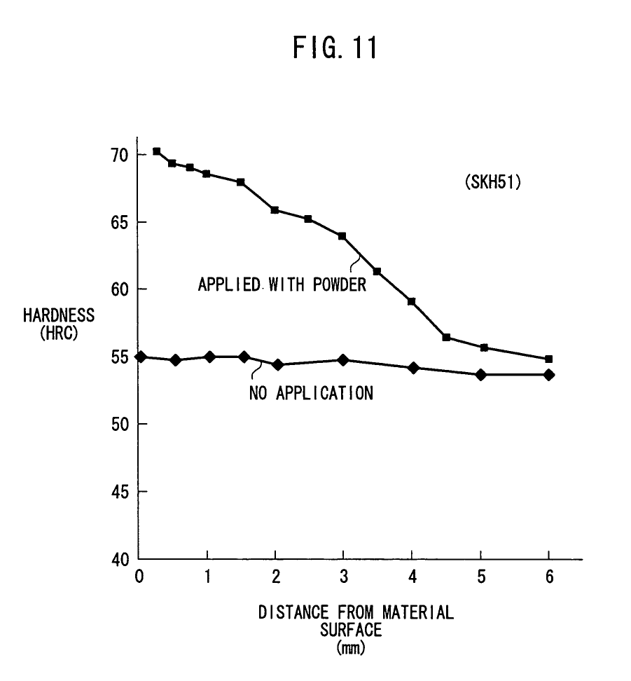

The respective columnar members were cut along the height direction thereof. HRC was measured at respective positions at every 0.5 mm along the height direction, from the center of the bottom surface. FIGS. 10 and 11 show graphs, which indicate the relationship between HRC and the distance from the surface, in combination with SKH51 and SKD11 materials to which no applying agent was used. Considering the measurement error for HRC, it is clear from FIG. 10 or 11 that hardness was increased, until reaching a depth of about 6 mm from the bottom surface, in each of the columnar members. Further, the produced carbides were identified, and as a result, the identified carbides were (Fe, W)₆C, (Fe, W)₂₃C₆, (Fe, Cr)₆C, and (Fe, Cr)₂₃C₆.

1. A layered Fe-based alloy comprising a base material, which is composed of an Fe-based alloy, and a diffusion layer which is formed by allowing a carbide to diffuse into said base material, the diffusion layer having a hardness higher than that of said base material, wherein:
a thickness of said diffusion layer, which is measured from a base point of a surface of said layered Fe-based alloy, is not less than 0.5 mm.

2. A layered Fe-based alloy, in which hardness is increased from a surface layer portion to an inside portion thereof, and comprising a diffusion layer that exists on an outer surface of said surface layer portion, wherein:
said diffusion layer contains a carbide formed by carbonizing a first element which has a property to increase hardness of an Fe-based alloy;
a second element other than said first element is contained in said Fe-based alloy, having an amount which is larger in said surface layer portion as compared with said inside portion thereof; and
an amount of said first element increases from said surface layer portion toward said inside portion.

3. A layered Fe-based alloy comprising a base material composed of an Fe-based alloy and a diffusion layer formed by allowing a carbide to diffuse into said base material, said diffusion layer having a hardness higher than that of said base material, wherein:
said hardness of said diffusion layer decreases at deeper inside positions, and a thickness of said diffusion layer, which is measured from a base point of a surface of said base material, is not less than 0.5 mm; and
a concentration-varied portion, having a hardness that increases as an amount of an element having a property to increase said hardness of said base material increases from a surface layer portion to an inside portion of said base material, is provided in a part of the base material in which said diffusion layer is absent.

4. The layered Fe-based alloy according to any one of claim 1, wherein said carbide is a carbide of Cr, W, Mo, V, Ni, or Mn.

5. The layered Fe-based alloy according to claim 4, wherein said carbide has a compositional formula of M₆C or M₂₃C₆ provided that M represents a metal element.

6. The layered Fe-based alloy according to an) one of claim 1, wherein said carbide is obtained by carbonizing a solid solution of Fe and at least one of Cr, W, Mo, V, Ni, and Mn.

7. The layered Fe-based alloy according to claim 6, wherein said carbide has a compositional formula of (Fe, M)₆C or (Fe, M)₂₃C₆ provided that M represents a metal element.

8. The layered Fe-based alloy according to claim 2, wherein said second element is C, Si, Cu, Ti, Al, or Mg.

9. A method for producing a layered Fe-based alloy comprising a base material composed of an Fe-based alloy and a diffusion layer formed by allowing a carbide to diffuse into said base material, said diffusion layer having a hardness higher than that of said base material, wherein a thickness of said diffusion layer, measured from a base point of a surface of said layered Fe-based alloy, is not less than 0.5 mm, the method comprising the steps of:
applying, to a surface of said Fe-based alloy, a metal powder to increase said hardness; and
heat-treating said Fe-based alloy with said metal powder applied thereto, so that at least carbon contained in said Fe-based alloy and said metal are reacted with each other to form said carbide, wherein said carbide is diffused into said Fe-based alloy.

10. The method for producing said layered Fe-based alloy according to claim 9, wherein Cr, W, Mo, V, Ni, or Mn is used as said metal.

11. A method for producing a layered Fe-based alloy having an increased hardness from a surface layer portion to an inside portion thereof, and further comprising a diffusion layer existing on an outer surface of said surface layer portion, wherein said diffusion layer contains a carbide formed by carbonizing a first element that has a property for increasing hardness of an Fe-based alloy, wherein a second element, other than said first element, is contained in said Fe-based alloy, said second element having an amount which is larger in said surface layer portion as compared with said inside portion, and wherein an amount of said first element increases from said surface layer portion to said inside portion, the method comprising the steps of:
applying, to a surface of said Fe-based alloy, a powder made up of a substance which contains said second element; and
heat-treating said Fe-based alloy with said powder applied thereto, so that said first element is diffused to said surface layer portion, and said first element reacts with carbon existing in said surface layer portion of said Fe-based alloy to form said carbide.

12. A method for producing a layered Fe-based alloy, comprising the steps of:
applying, to a surface of an Fe-based alloy, a powder made up of a substance containing a first element which increases hardness, while applying, to a part of the Fe-based alloy other than where said first element was applied, a powder made up of a substance containing a second element, wherein the second element is different from said first element and is contained in said Fe-based alloy, or applying, to said surface of said Fe-based alloy, said powder made up of said substance containing said second element, while applying said substance containing said first element to a part of the Fe-based alloy other than where said second element was applied;
applying heat treatment to said Fe-based alloy after applying said powders thereto, each powder containing said first element or said second element respectively, so that a diffusion layer, having a thickness of not less than 0.5 mm and a hardness higher than that of a base material, is provided at said part to which said powder of said substance containing said first element was applied, while a concentration-varied portion, in which a hardness thereof is increased as an amount of an element having a property to increase said hardness of said base material is increased from a surface layer portion to an inside portion of said base material, is provided at said part to which said powder of said substance containing said second element was applied,
wherein said diffusion layer is provided such that said first element is diffused into said Fe-based alloy, thereby diffusing said carbide into the Fe-based alloy by causing a reaction with carbon of said Fe-based alloy, and
wherein said concentration-varied portion is provided such that said first element of said Fe-based alloy is diffused from said inside portion to said surface layer portion of said Fe-based alloy, and carbon, which exists in said surface layer portion, reacts with said first element to form a carbide-containing coating, thereby discharging said first element from said base material.

13. The method for producing said layered Fe-based alloy according to claim 11, wherein Cr, W, Mo, V, Ni, or Mn is used as said first element.

14. The method for producing said layered Fe-based alloy according to claim 11, wherein C, Si, Cu, Ti, Al, or Mg is used as said second element.

15. The method for producing said layered Fe-based alloy according to claim 10, further comprising a step of removing said coating.

16. The layered Fe-based alloy according to claim 2, wherein said carbide is a carbide of Cr. W, Mo, V, Ni, or Mn.

17. The layered Fe-based alloy according to claim 16, wherein said carbide has a compositional formula of M₆C or M₂₃C₆ provided that M represents a metal element.

18. The layered Fe-based alloy according to claim 2, wherein said carbide is obtained by carbonizing a solid solution of Fe and at least one of Cr, W, Mo, V, Ni, and Mn.

19. The layered Fe-based alloy according to claim 18, wherein said carbide has a compositional formula of (Fe, M)₆C or (Fe, M)₂₃C₆ provided that M represents a metal element.

20. The layered Fe-based alloy according to claim 3, wherein said carbide is a carbide of Cr, W, Mo, V, Ni, or Mn.

21. The layered Fe-based alloy according to claim 20, wherein said carbide has a compositional formula of M₆C or M₂₃C₆ provided that M represents a metal element.

22. The layered Fe-based alloy according to claim 3, wherein said carbide is obtained by carbonizing a solid solution of Fe and at least one of Cr, W, Mo, V, Ni, and Mn.

23. The layered Fe-based alloy according to claim 22, wherein said carbide has a compositional formula of (Fe, M)₆C or (Fe, M)₂₃C₆ provided that M represents a metal element.

24. The method for producing said layered Fe-based alloy according to claim 12, wherein Cr, W, Mo, V, Ni, or Mn is used as said first element.

25. The method for producing said layered Fe-based alloy according to claim 12, wherein C, Si, Cu, Ti, Al, or Mg is used as said second element.
